(19) United States
(12) Patent Application Publication
(10) Pub. No.: US 2012/0256853 A1
(43) Pub. Date: Oct. 11, 2012

(54) DETECTION METHOD FOR TOUCH INPUT DEVICE

(75) Inventor: CHIEN YU CHAN, HSINCHU (TW)

(73) Assignee: RAYDIUM SEMICONDUCTOR CORPORATION, HSINCHU (TW)

(21) Appl. No.: 13/404,989

(22) Filed: Feb. 24, 2012

(30) Foreign Application Priority Data
Apr. 7, 2011 (TW) 100111955

(51) Int. Cl. G06F 3/041

(52) U.S. Cl. 345/173

(57) ABSTRACT

The present invention discloses a detection method for a touch input device. The touch input device includes a touch panel and a control device. The touch panel includes a plurality of X-directional lines and a plurality of Y-directional lines, which are arranged intersecting one another. The method includes the steps of: configuring the X-directional lines as scan lines and the Y-directional lines as sense lines; dividing the scan lines into a plurality of groups of scan lines; during each scanning operation, outputting a driving signal to one of the plurality of groups of scan lines; after each scanning operation, receiving voltages on the sense lines and converting the voltages into a plurality of digital signals; storing the digital signals into a storage unit; and determining a touch status based on the digital signals.

### BACKGROUND

1. Technical Field

The present invention relates to a detection method for a touch input device.

2. Related Art

Recently, touch panels have been widely applied in the fields of home appliance products, communication devices, and electronic information devices, among others. Touch panels are usually applied as input interfaces of consumer electronics, such as personal digital assistants (PDA), game consoles, etc. The recent trend of integrating a touch panel with a display screen allows a user to use a finger or a stylus to select an icon displayed on the panel, whereby the PDA, electronic product or game console executes the indicated function. This type of touch panel may also be applied in a public information query system, allowing the public to operate the system more efficiently.

FIG. 1 is a schematic diagram illustrating a prior art touch panel 10. The touch panel includes a plurality of X-directional lines X₁ to X_{M} and a plurality of Y-directional lines Y₁ to Y_{N}, wherein M and N are different positive integers or the same positive integer. The X-directional lines X₁ to X_{M} and the Y-directional lines are buried at different layers of the touch panel 10. Referring to FIG. 1, the X-directional lines and the Y-directional lines are arranged intersecting one another so as to form a sensing grid. In the sensing grid, a parasitic mutual capacitor C_{M} is formed between each X-directional line and each Y-directional line.

In a prior art operating method, a driving signal (usually a square wave signal) is applied to an X-directional line or a Y-directional line. Through the coupling effect of mutual capacitors C_{M}, a plurality of induced voltages are generated on the corresponding Y-directional lines or X-directional lines. Because the values of the induced voltages change depending on how a user touches the lines, a touching position of the user can be determined by detecting differences of the induced voltages.

In the prior art technology, however, determining a touch status of the touch panel 10 requires waiting for driving signals to be applied to M X-directional lines or N Y-directional lines, and for the sensing operation of the corresponding N Y-directional lines or M X-directional lines to be completed, so that touch information of the touch panel 10 may be obtained. As a result, a report rate of the touch panel 10 is limited by scanning time of the lines and cannot be raised. This limitation is further exacerbated by increases in the size of the touch panel. Therefore, there is a significant need for a detection method adapted for the touch panel to address the foregoing problem.

### SUMMARY

The present invention discloses a detection method for a touch input device. The touch input device includes a touch panel and a control device. The touch panel includes a plurality of X-directional lines and a plurality of Y-directional lines, which are arranged intersecting one another. The method includes the steps of: configuring the X-directional lines as scan lines and configuring the Y-directional lines as sense lines; dividing the scan lines into a plurality of groups of scan lines; during a first scanning operation, outputting a driving signal to one of the plurality of groups of scan lines; after the first scanning operation, receiving voltages on the sense lines and converting the voltages into a plurality of first digital signals; storing the first digital signals to a storage unit; during a second scanning operation, outputting the driving signal to another group of the plurality of groups of scan lines; after the second scanning operation, receiving voltages on the sense lines and converting the voltages into a plurality of second digital signals; storing the second digital signals into the storage unit; and determining a touch status of the touch panel based on the first and second digital signals.

The present invention also discloses another detection method for a touch input device. The touch input device includes a touch panel and a control device. The touch panel includes a plurality of X-directional lines and a plurality of Y-directional lines, which are arranged intersecting one another. The method includes the steps of: configuring the X-directional lines as scan lines and configuring the Y-directional lines as sense lines; outputting a driving signal to one of the scan lines; selecting a number of sense lines to be measured after each scanning operation; receiving voltages on the corresponding sense lines in a configured sequence based on the number of sense lines; converting the voltages on the sense lines received each time into a plurality of digital signals; storing the digital signals converted each time to a storage unit; and determining a touch status of the touch panel based on the stored result of the storage unit.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed might be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon reference to the accompanying drawings in which:

FIG. 1 is a schematic diagram illustrating a prior art touch panel;

FIG. 2 is a schematic block diagram illustrating a touch input device according to an embodiment of the present invention;

FIG. 3 is a flow chart illustrating a detection method for a touch input device according to an embodiment of the present invention;

FIG. 4 illustrates a scanning method according to an embodiment of the present invention;

FIG. 5 is a schematic diagram illustrating a storage unit according to an embodiment of the present invention;

FIG. 6 illustrates a scanning method according to an embodiment of the present invention; and

FIGS. 7A and 7B illustrate a detection method for induced voltages according to an embodiment of the present invention.

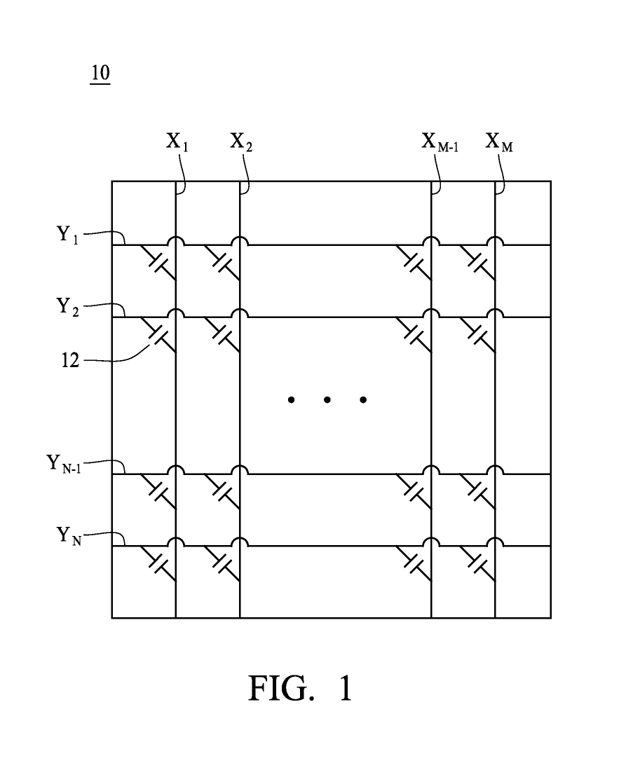

### DESCRIPTION OF THE EMBODIMENTS

In order to more clearly describe detection methods for a touch input device according to the present invention, the touch input device executing the methods of the present invention is described as follows.

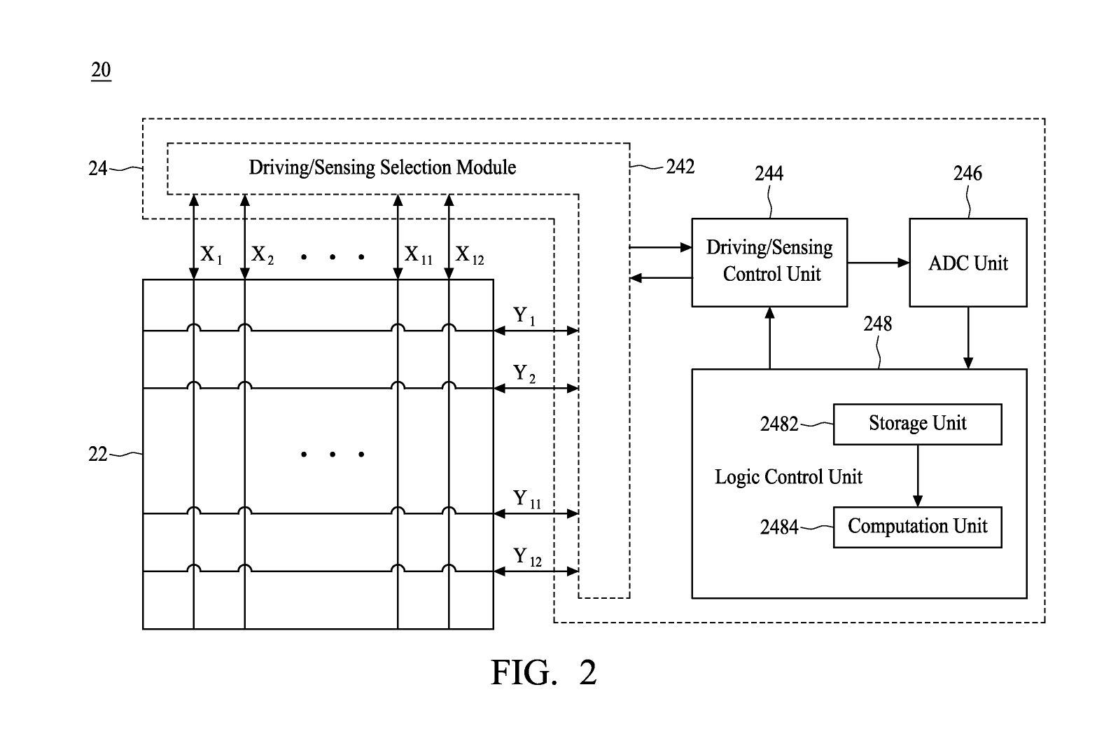

FIG. 2 illustrates a touch input device 20 according to an embodiment of the present invention, wherein the touch input device 20 includes a touch panel 22 and a control device 24. For the purpose of simplification, the touch panel 22 in FIG. 2 is represented by 12 X-directional lines X₁ to X₁₂ and 12 Y-directional lines Y₁ to Y₁₂. The X-directional lines X₁ to X₁₂ and the Y-directional lines Y₁ to Y₁₂ are buried at different layers of the touch panel 22. Referring to FIG. 2, the X-directional lines X₁ to X₁₂ and the Y-directional lines Y₁ to Y₁₂ are arranged intersecting one another, to form a rectangular grid. In the rectangular grid, a mutual capacitor is formed between each X-directional line and each Y-directional line. In addition, the control device 24 includes a driving/sensing selection module 242, a driving/sensing control unit 244, an analog to digital conversion (ADC) unit 246 and a logic control unit 248.

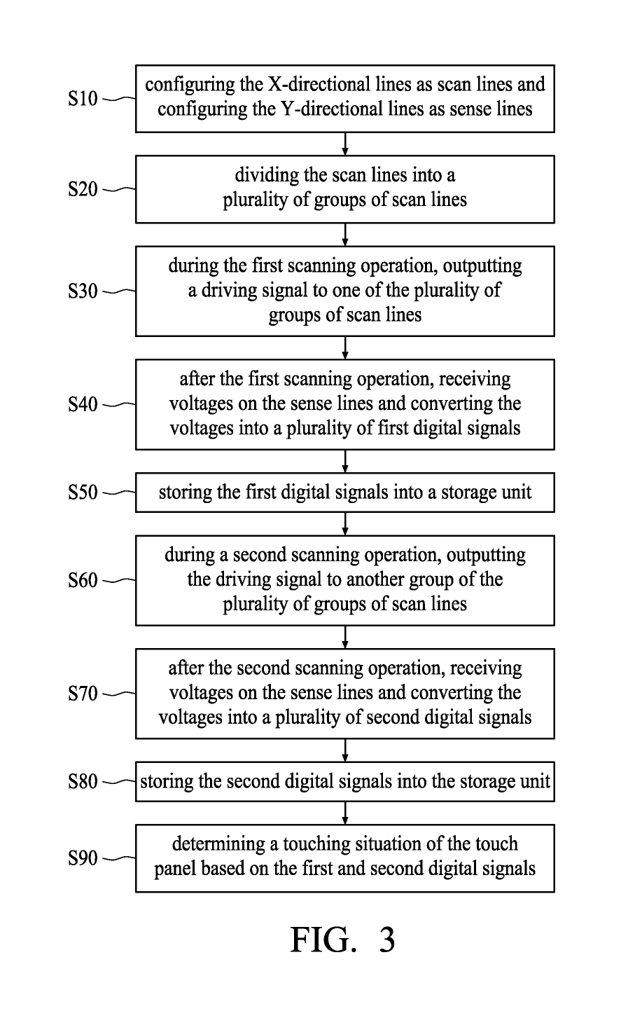

FIG. 3 is a flow chart illustrating a detection method of the touch input device 20 according to an embodiment of the present invention. The detection method includes the steps of: configuring the plurality of X-directional lines as scan lines and configuring the plurality of Y-directional lines as sense lines (Step S10); dividing the scan lines into a plurality of groups of scan lines (Step S20); during a first scanning operation, outputting a driving signal to one of the plurality of groups of scan lines (Step S30); after the first scanning operation, receiving voltages on the sense lines and converting the voltages into a plurality of first digital signals (Step S40); storing the first digital signals into a storage unit (Step S50); during a second scanning operation, outputting the driving signal to another group of the plurality of groups of scan lines (Step S60); after the second scanning operation, receiving voltages on the sense lines and converting the voltages into a plurality of second digital signals (Step S70); storing the second digital signals into the storage unit (Step S80), and determining a touch status of the touch panel based on the first and second digital signals (Step S90). Details of the detection method according to the present embodiment are provided below.

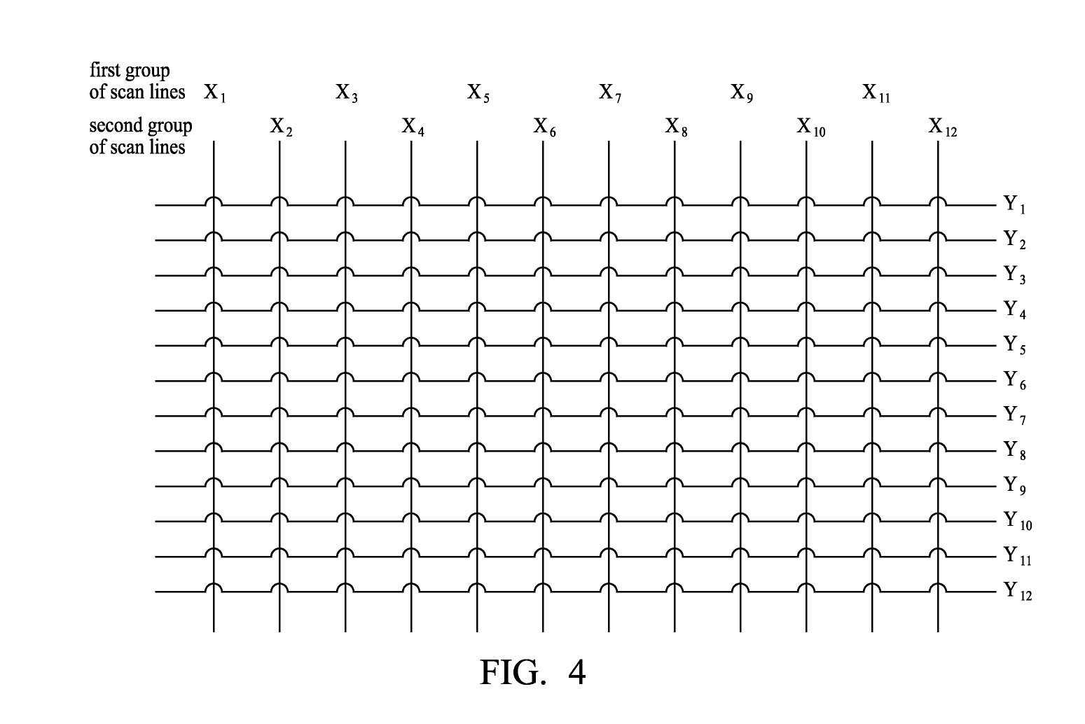

Referring to FIG. 2, the driving/sensing control unit 244 in the control device 24 first outputs a signal to the driving/sensing selection module 242 to execute a scanning operation of the touch panel 22. During the first scanning operation, if the X-directional lines X₁ to X₁₂ are configured as scan lines and the Y-directional lines Y₁ to Y₁₂ are configured as sense lines, the driving/sensing selection module 242 will output a driving signal to the X-directional lines X₁ to X₁₂. According to an embodiment of the present invention, in order to reduce a scanning time to increase a report rate of the touch panel 22, as illustrated in FIG. 4, the X-directional lines X₁ to X₁₂ are divided into two groups of scan lines, wherein the first group of scan lines consists of the odd scanning lines X₁, X₃, . . . , X₁₁, and the second group of scan lines consists of the even scanning lines X₂, X₄, . . . , X₁₂.

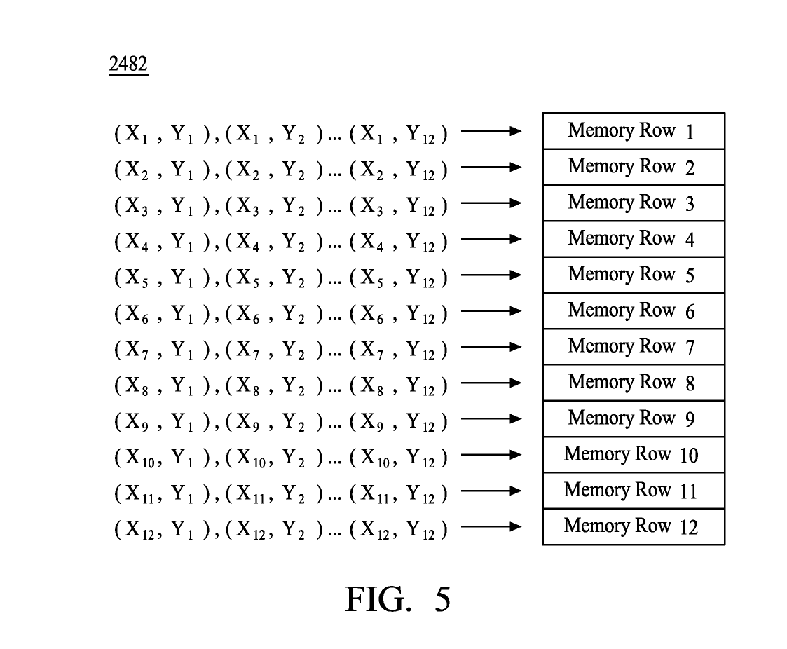

Next, during the first scanning operation, the driving signal is applied to the first group of scan lines X₁, X₃, . . . , X₁₁ in sequence along a fixed direction. By a plurality of analog to digital converters in the analog to digital conversion module 246, voltages on the Y-directional sense lines Y₁-Y₁₂ corresponding to the scan lines X₁, X₃, . . . , X₁₁ are converted into digital signals and stored in the storage unit 2482 in sequence. In the present embodiment, the storage unit 2482 includes a plurality of memory rows 1 to 12, as illustrated in FIG. 5. Each memory row is configured to store digital signals representing the induced voltages on the sense lines. For example, when the driving signal is applied to the scan line X₁, the memory row 1 is used to store the digital signals representing each point (X₁, Y₁), (X₁, Y₂), . . . , (X₁, Y₁₂), and when the driving signal is applied to the scan line X₂, the memory row 2 is used to store the digital signals representing each point (X₂, Y₁), (X₂, Y₂), . . . , (X₂, Y₁₂). Therefore, after the first scanning operation is finished, the odd memory rows 1, 3, . . . , 11 in the storage unit 2482 update the stored data after the current scanning operation.

Next, the touch input device 20 performs a second scanning operation. During the second scanning operation, the driving signal is applied to the scan lines X₂, X₄, . . . , X₁₂ in the second group of scan lines. Similarly, by the plurality of analog to digital converters in the analog to digital conversion module 246, the Y-directional sense lines Y₁ to Y₁₂ corresponding to the scan lines X₂, X₄, . . . , X₁₂ are converted into digital signals, and stored in the even memory rows 2, 4, . . . , 12 in the storage unit 2482 in sequence.

After each scanning operation, the touch input device updates the data in the memory rows of the storage unit 2482. The data in the storage unit 2482 is then sent to a computation unit 2484. The computation unit 2484 calculates the current touch status of the touch panel 22 according to an algorithm. In the present embodiment, after the first scanning operation is finished, the odd memory rows 1, 3, . . . , 11 in the storage unit 2482 store the data from that scanning operation, and the even memory rows 2, 4, . . . , 12 store the digital data from the last scanning operation. Therefore, compared to the prior art technology, half of the scanning time can be eliminated by using the detection method of the present embodiment. After each scanning operation, the computation unit 2484 can quickly calculate a touch status of the Y-directional sense lines based on the data in the storage unit 2482.

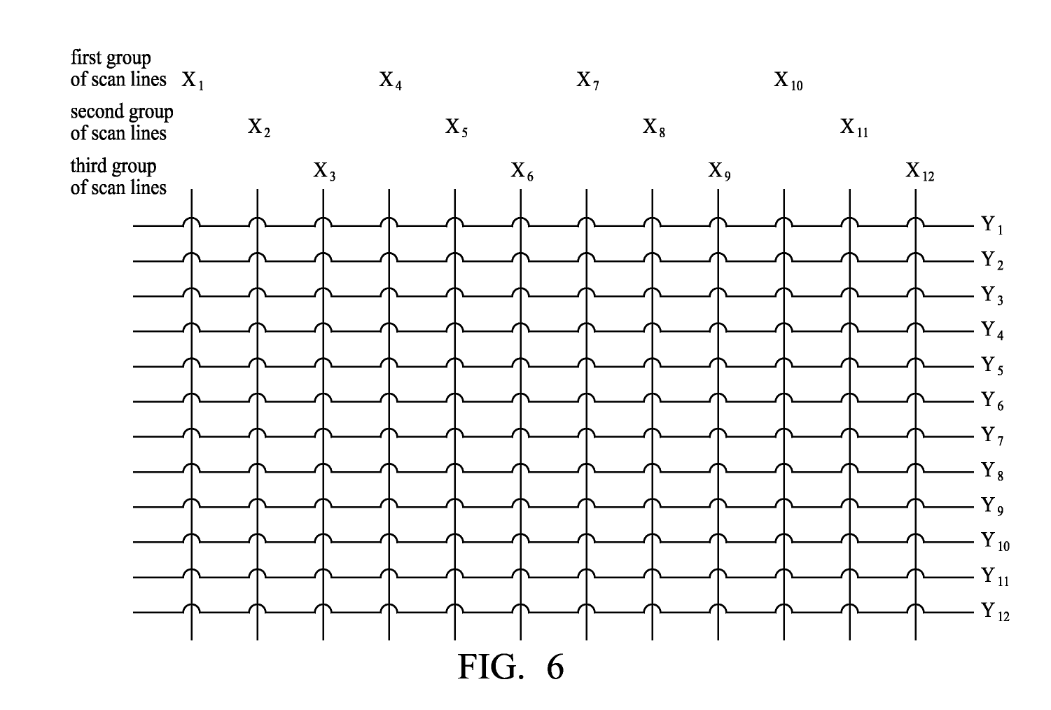

According to another embodiment of the present invention, in order to further reduce the scanning time to increase the report rate of the touch panel 22, as illustrated in FIG. 6, the X-directional lines X₁ to X₁₂ are divided into three groups of scan lines, wherein the first group of scan lines consists of scan lines X₁, X₄, X₇ and X₁₀, the second group of scan line consists of scan lines X₂, X₅, X₈ and X₁₁, and the third group of scan lines consists of scan lines X₃, X₆, X₉ and X₁₂. By similar operations, after a first scanning operation, voltages on the Y-directional sense lines Y₁ to Y₁₂ are converted into digital signals and stored in the memory rows 1, 4, 7 and 10 in sequence in the storage unit 2482. After a second scanning operation, voltages on the Y-directional sense lines Y₁ to Y₁₂ are converted into digital signals and stored in the memory rows 2, 5, 8 and 11 in sequence in the storage unit 2482. After a third scanning operation, voltages on the Y-directional sense lines Y₁ to Y₁₂ are converted into digital signals and stored in the memory rows 3, 6, 9 and 12 in sequence in the storage unit 2482. Therefore, compared to the prior art technology, two-thirds of the scanning time can be eliminated by using the detection method of the present embodiment. After each scanning operation, the computation unit 2484 can quickly calculate a touch status of the Y-directional sense lines based on the current scanning result and the last scanning result.

In the foregoing embodiments, the X-directional scan lines X₁ to X₁₂ may be divided into two or three groups of scan lines. However, the present invention is not limited to such implementation. The X-directional lines may be divided into four or more groups of scan lines to perform interlacing scanning. In addition to the advantage of the increased report rate due to the reduction of the scanning time, dividing the X-directional scan lines X₁ to X₁₂ into multiple groups of scan lines may also reduce power consumption of the control device during each scanning operation. After the scan of the X-directional lines X₁ to X₁₂ is completed, the Y-directional lines Y₁ to Y₁₂ may be configured as scan lines and an interlacing scan may be performed.

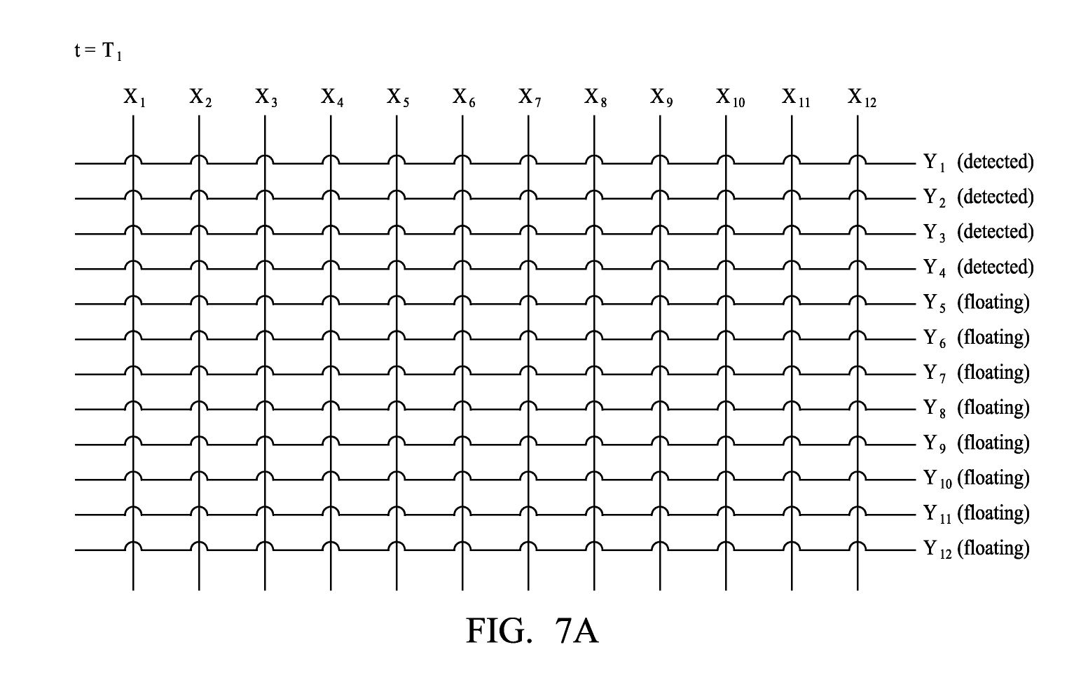

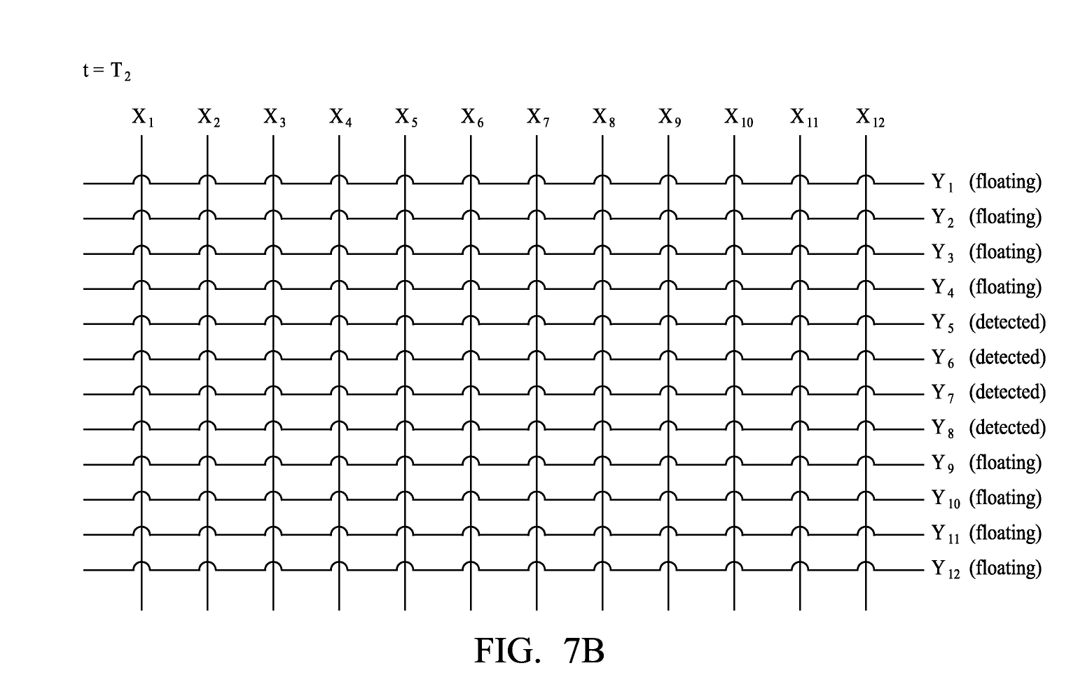

In the foregoing embodiments, the induced voltages on the Y-directional sense lines Y₁ to Y₁₂ are fully transmitted to the control device 24 and converted into digital signals. However, according to another embodiment, the control device 24 receives the induced voltages of a portion of the Y-directional sense lines Y₁ to Y₁₂. FIGS. 7A and 7B illustrate a detection method of induced voltages of the control device 24 according to another embodiment. Referring to FIG. 7A, at the time instance t=T₁, the control device 24 detects the voltages on the Y-directional sense lines Y₁ to Y₄, and the other sense lines are floating or grounded; at the next time instance t=T₂, the control device 24 detects the voltages on the Y-directional sense lines Y₅ to Y₈, and the other sense lines are floating or grounded; and so forth. Since the control device 24 only receives the induced voltages of a portion of the Y-directional sense lines Y₁ to Y₁₂, fewer connecting wires are required between the control device 24 and the control panel 22, and the analog to digital conversion unit 246 may include fewer analog to digital converters.

The induced voltage detection method illustrated in FIGS. 7A and 7B does not limit the scanning method used for the X-directional scan lines X₁ to X₁₂. That is, the X-directional scan lines X₁ to X₁₂ may be scanned in an interlacing manner. Alternatively, the X-directional scan lines may be scanned from X₁ to X₁₂ in sequence following a traditional manner Moreover, according to the present embodiment, the voltages on the Y-directional sense lines Y₁ to Y₁₂, after being divided into groups, are received by the control device 24 in sequence along a fixed direction. According to another embodiment of the present invention, the Y-directional sense lines Y₁ to Y₁₂, after being divided into groups, may be received by the control device 24 in an interlacing manner. In other words, at time instance t=T₁, the control device 24 detects the voltages on the Y-directional sense lines Y₁-Y₄, and the other sense lines are floating or grounded; at the next time instance t=T₂, the control device detects voltages on the Y-directional sense lines Y₉ to Y₁₂, and the other sense lines are floating or grounded; and at the next time instance t=T₃, the control device 24 detects voltages on the Y-directional sense lines Y₅ to Y₈, and the other sense lines are floating or grounded.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A detection method for a touch input device, the touch input device comprising a touch panel and a control device, the touch panel comprising a plurality of X-directional lines and a plurality of Y-directional lines, and the X-directional lines and Y-directional lines arranged intersecting one another, the method comprising the steps of:
configuring the X-directional lines as scan lines and configuring the Y-directional lines as sense lines;
dividing the scan lines into a plurality of groups of scan lines;
during a first scanning operation, outputting a driving signal to one of the plurality of groups of scan lines;
after the first scanning operation, receiving voltages on the sense lines and converting the voltages into a plurality of first digital signals;
storing the first digital signals to a storage unit;
during a second scanning operation, outputting the driving signal to another group of the plurality of groups of scan lines;
after the second scanning operation, receiving voltages on the sense lines and converting the voltages into a plurality of second digital signals;
storing the second digital signals into the storage unit; and
determining a touch status of the touch panel based on the first and second digital signals.

2. The detection method according to claim 1, wherein the step of outputting the driving signal to the plurality of scan lines comprises:
outputting the driving signal to one of the scan lines of one of the plurality of groups of scan lines in sequence along an X direction.

3. The detection method according to claim 1, wherein the step of dividing the scan lines into a plurality of groups of scan lines comprises:
dividing the scan lines into two groups of scan lines, wherein the first group of scan lines consists of the odd scan lines, and the second group of scan lines consists of the even scan lines.

4. The detection method according to claim 1, wherein the step of dividing the scan lines into a plurality of groups of scan lines comprises:
dividing the scan lines into three groups of scan lines, wherein the first group of scan lines consists of the (3N+1)th scan lines, the second group of scan lines consists of the (3N+2)th scan lines, and the third group of scan lines consists of the (3N+3)th scan lines, wherein N is equal to 0 or is a positive integer.

5. The detection method according to claim 1, wherein the driving signal is sent out by the control device and the number of groups of scan lines is determined by power consumption of the control device.

6. The detection method according to claim 1, wherein the step of receiving the voltages on the sense lines comprises:
dividing the voltages on the sense lines into a plurality of groups of voltages; and
receiving the voltage of one of the plurality of groups of voltages in sequence along a fixed direction.

7. The detection method according to claim 1, wherein the step of receiving the voltages on the sense lines comprises:
dividing the voltages on the sense lines into a plurality of groups of voltages; and
receiving the voltages of one of the plurality of groups of voltages in an interlacing manner.

8. A detection method for a touch input device, the touch input device comprising a touch panel and a control device, the touch panel comprising a plurality of X-directional lines and a plurality of Y-directional lines, and the X-directional lines and Y-directional lines arranged intersecting one another, the method comprising the steps of:
configuring the X-directional lines as scan lines and configuring the Y-directional lines as sense lines;
outputting a driving signal to one of the scan lines;
selecting a number of sense lines to be measured after each scanning operation;
receiving voltages on the corresponding sense lines in a configured sequence based on the number of sense lines;
converting the voltages on the sense lines received each time into a plurality of digital signals;
storing the digital signals converted each time to a storage unit; and
determining a touch status of the touch panel based on the stored result of the storage unit.

9. The detection method according to claim 8, wherein the step of receiving voltages on the corresponding sense lines in a configured sequence comprises:
receiving the voltages on the corresponding Y-directional sense lines in sequence along a fixed direction.

10. The detection method according to claim 8, wherein the step of receiving voltages on the corresponding sense lines in a configured sequence comprises:
receiving the voltages on the corresponding Y-directional sense lines in an interlacing manner.
